(19) United States
(12) Patent Application Publication
(10) Pub. No.: US 2022/0217245 A1
(43) Pub. Date: Jul. 7, 2022

(54) OBTAINING DEFAULT CONFIGURATION OF APPLICATION

(71) Applicant: HEWLETT-PACKARD DEVELOPMENT COMPANY, L.P., Spring, TX (US)

(72) Inventors: Junghun KIM, Seongnam-si (KR); Minyoung SON, Seongnam-si (KR); Sangmi KIM, Seongnam-si (KR); Sejong KIM, Seongnam-si (KR); Min NAMGOONG, Seongnam-si (KR); Jinkyu KOOK, Seongnam-si (KR); Hyein LEE, Seongnam-si (KR); Hyunwoo YOO, Seongnam-si (KR); Byeongju HWANG, Seongnam-si (KR)

(73) Assignee: HEWLETT-PACKARD DEVELOPMENT COMPANY, L.P., Spring, TX (US)

(21) Appl. No.: 17/606,941

(22) PCT Filed: Jun. 5, 2020
(86) PCT No.: PCT/US2020/036271

§ 371 Date: Oct. 27, 2021

(30) Foreign Application Priority Data
Dec. 13, 2019 (KR) 10-2019-0166491

(51) Int. Cl. H04N 1/00

(52) U.S. Cl. CPC H04N 1/00938; H04N 1/0097; H04N 1/00244; H04N 1/00954; H04N 1/00973

(57) ABSTRACT

An example computing apparatus requests a server to transfer default configuration information of a target application among a plurality of applications and receives the default configuration information from the server. The computing apparatus provides an interface for modifying a configuration of the target application based on the default configuration information and stores the configuration information modified through the interface. The computing apparatus configures the target application of a target image forming apparatus among a plurality of image forming apparatuses using the modified configuration information.

### BACKGROUND

When a computing device displays a list of devices, such as printers, on which an application is installed and selects a certain device, a setting of the application in the selected device may be converted into a file and stored in the local environment of the computing device.

### BRIEF DESCRIPTION OF THE DRAWINGS

Various examples will be described below by referring to the following figures.

FIG. 1 is a diagram showing a network-based image forming apparatus management system according to an example.

FIG. 2, FIG. 5, and FIG. 6 are diagrams showing a method of configuring an application according to various examples.

FIG. 3 is a diagram showing an application screen according to an example.

FIG. 4 is a diagram showing configuration information stored in a database according to an example.

FIG. 7 and FIG. 8 are diagrams showing a method of applying an application configuration according to various examples.

FIG. 9, FIG. 10, and FIG. 11 are diagrams showing a method of applying a task set according to various examples.

FIG. 12 is a diagram showing a computing device according to an example.

### DETAILED DESCRIPTION

As those skilled in the art will realize, the following described examples may be modified in various different ways, all without departing from the spirit or scope of the present invention. In order to clarify the present disclosure, parts that are not relevant to the description may be omitted, and the same elements or equivalents are referred to by the same reference numerals throughout the specification.

As used herein, when a part is referred to “include” or “comprise” a certain element, it indicates that it may further include or comprise other elements rather than exclude other elements, unless specifically indicated otherwise.

The term “transmit”, “transfer”, “provide”, “receive”, or “acquire” may be used to include not only direct transmission, transfer, provision, reception, or acquisition but also indirect transmission, transfer, provision, reception, or acquisition through another device or using a bypass.

The singular forms “a”, “an”, and “the” may be intended to include the plural forms as well, unless the explicit expression such as “one” or “singular” is used.

The expression “and/or” may include each of the referred elements and every combination of one or more thereof.

Although the terms first, second, and the like may be used herein to describe various elements, components, steps and/or operations, these terms may be used to distinguish one element, component, step or operation from another element, component, step, or operation. Thus, a first element component, step or operation discussed below could be termed a second element, component, step or operation without departing from the scope of the present invention.

In a flowchart described with reference to the accompanying drawings, an operation order may be changed, several operations may be merged, a certain operation may be divided, and a specific operation may be omitted.

An application may refer to a program that is installed and executed on a device and is designed to achieve a specific purpose or to implement a specific function. For example, the application may be a file sharing application, a document print application, a document scan application, and the like. The application may include a program that addresses a software or hardware issue of the device.

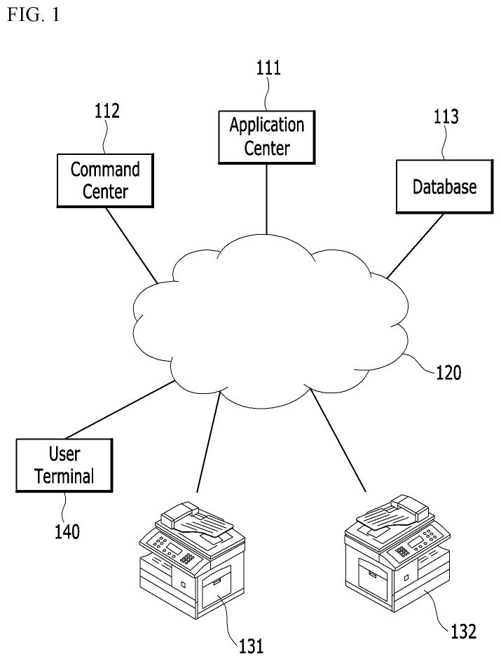

FIG. 1 is a diagram showing a network-based image forming apparatus management system according to an example.

Referring to FIG. 1, an application center 111, a command center 112, and a database 113 may be connected to devices 131 and 132 and a user terminal 140 through a network 120.

The application center 111, the command center 112, the database 113, and the user terminal 140 may be implemented as computing devices. In some examples, the application center 111, the command center 112, and the database 113 may be implemented as cloud-based servers. In some examples, the database 113 may be implemented in a storage device of the command center 112. In some examples, at least a part of the application center 111, the command center 112, and the database 113 may be implemented with one computing device.

Each of the devices 131 and 132 may be include image forming apparatus that generates, prints, receives, and transmits image data. Some examples of the image forming apparatus include a printer, a scanner, a copier, a fax machine, or a multifunction printer incorporating these functions. Each of the devices 131 and 132 may include a memory and a processor.

The application center 111 may store a new application or an updated application and may store a default configuration file of the application. The default configuration file may include default configuration information including configuration values that are applied to the application by default when the application is installed. The default configuration value may include, for example, a configuration value regarding a printing medium (e.g., size of paper, type of paper, etc.), a configuration value regarding a printing resolution, and the like. The application center 111 may support installation of the application.

The command center 112 may retrieve the default configuration file from the application center 111 and may modify the configuration of the application. The command center 112 may communicate with the device 131 or 132 to manage function configuration of the device 131 or 132. In some examples, the command center 112 and the application center 111 may be provided as separate servers. In some examples, the command center 112 and the application center 111 may be provided as one server.

The database 113 may store configuration information of the application modified in the command center 112. In some examples, the database 113 may be implemented in a server provided separately. In some examples, the database 113 may be implemented in the command center 112.

The device 131 or 132 may provide system services such as function configuration of the device and installation, execution, or management of applications, and may install and execute various applications. The application may read configuration values and apply them to an application execution environment on the device. In some examples, the device 131 or 132 may include a configuration manager. The configuration manager may receive configuration information of the application (e.g., the configuration file), and transfer the configuration values specified in the configuration information of the application to the application when executing the application.

The user terminal 140 may be a terminal used by a user. The user may be, for example, a reseller of the devices 131 and 132, a manager of a client company (e.g., a company that has purchased the devices 131 and 132), a general user of the client company, etc.

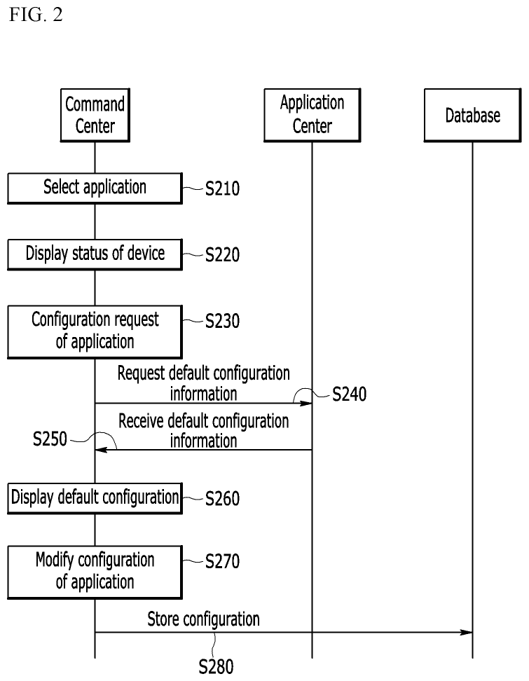

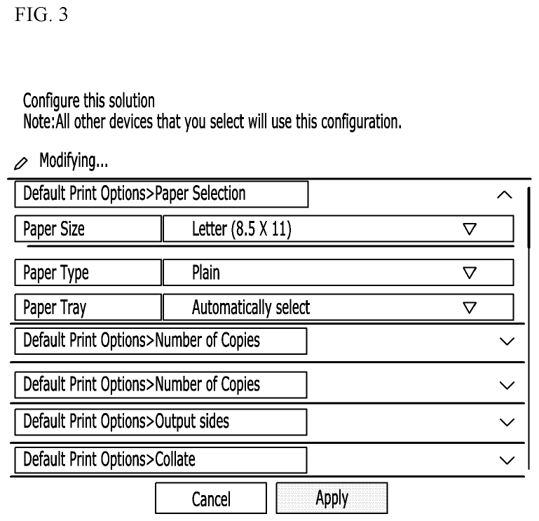

Various examples in which a command center stores configuration information of a specific application are described with reference to FIG. 2 to FIG. 6.

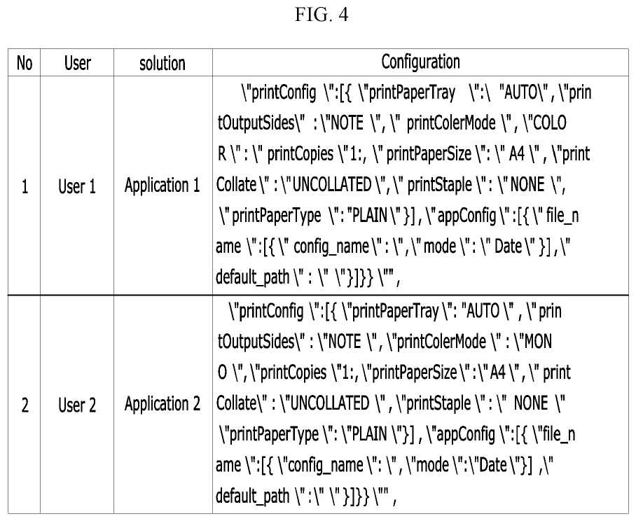

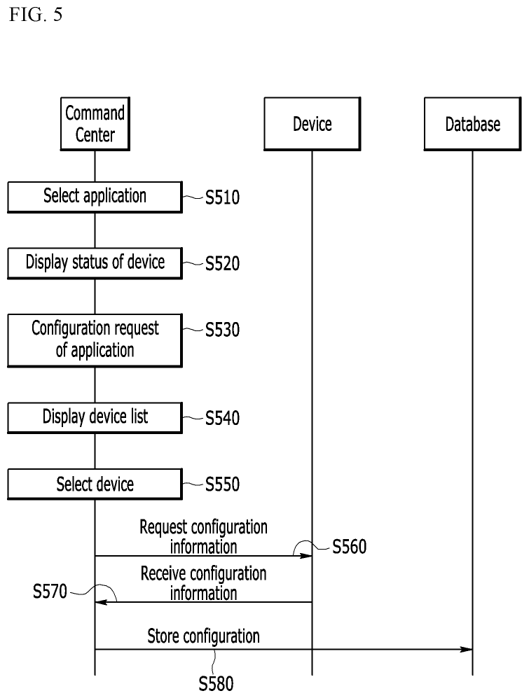

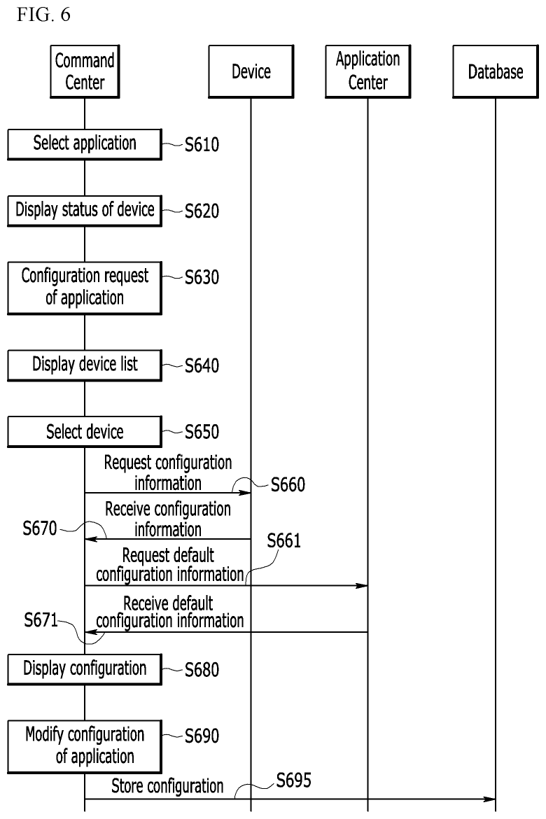

FIG. 2, FIG. 5, and FIG. 6 are diagrams showing a method of configuring an application according to various examples, FIG. 3 is a diagram showing an application according to an example, and FIG. 4 is a diagram showing configuration information stored in a database according to an example.

Referring to FIG. 2, a command center may receive a selection of a target application from among a plurality of applications from a user (e.g., a user terminal) at operation S210. The command center may display a status of each device related to the target application at operation S220. In some examples, the status of each device may include a status as to whether the target application is installed on the device. In some examples, the command center may display a list of devices on which the target application is installed.

When the command center receives a configuration request of the target application from the user at operation S230, the command center may request the application center to transfer default configuration information of the target application at operation S240. The command center may receive default configuration information of the target application from the application center at operation S250. In some examples, the application center may provide the default configuration information as a file including the default configuration information. In some examples, the default configuration information may include configuration item information of an application, a default configuration value, and other configuration values, which may be selected besides the default configuration value, of each configuration item.

The command center may provide an application configuration interface in which default configuration information is displayed based on the received default configuration information at operation S260. In some examples, the application configuration interface may be displayed on the user terminal so that the user may modify the configuration information. In some examples, the application configuration interface may provide an interface for selecting a configuration value other than the default configuration value in a state in which the default configuration value is set for each configuration item of the target application. Accordingly, the user can modify the configuration of the target application based on the default configuration.

For example, as shown in FIG. 3, the application configuration interface may display various configuration items used to form an image in the device, and may provide an interface from which the other configuration value can be selected while the default configuration value is displayed for each configuration item. For example, when the device performs a printing function, the various configuration items may include an item for paper selection, an item for the number of copies, an item for output sides, and an item for collate. Further, some configuration items, upon being selected, may display a plurality of additional items. For example, when the item for paper selection is selected, an item for paper size, an item for paper type, and an item for paper tray may be displayed as the additional items. Furthermore, although only some configuration items are displayed in FIG. 3, various configuration items may be additionally displayed through scrolling.

When the modification of the configuration of the application is completed through the application configuration interface at operation S270, the command center may store the modified configuration information in a database at operation S280. In some examples, the command center may store the modified configuration information in the database in association with information of the application. The information of the application may include, for example, identification information (e.g., a name) of the application or version information of the application. The command center may store the configuration information for each application. In some examples, the command center may store the received configuration information in the database in association with the information of the application and user information. The command center may store the configuration information for each application and each user.

For example, as shown in FIG. 4, the configuration value of each configuration item may be stored in association with user information, application identification information, and application version information. As an example, configuration information (\“printConfig\”) of application “HP for Dropbox” version 2 for user 1, a paper tray (\“printPaperTray\”) may be configured as \“Auto\”.

According to the above-described examples, the application configuration can be modified based on the default configuration. In addition, since the modified configuration information is stored together with the application information, the stored configuration information can be used to modify the configuration of a specific application on a desired device.

Referring to FIG. 5, a command center may receive a selection of a target application from among a plurality of applications from a user (e.g., a user terminal) at operation S510. The command center may display a status of each device related to the target application at operation S520. In some examples, the status of each device may include a status as to whether the target application is installed on the device.

When the command center receives a configuration request of the target application from the user at operation S530, a list of devices on which the target application is installed may be displayed at operation S540. When receiving a selection of a source device from the user at operation S550, the command center may request the source device to transfer configuration information of the target application at operation S560. The command center may receive the configuration information of the target application from the source device at operation S570 and may store the received configuration information in a database at operation S580. In some examples, the source device may provide the configuration information as a file including the configuration information. In some examples, the configuration information may include a configuration value of each configuration item of the application that has been configured in the source device. In some examples, the command center may store the received configuration information in a database in association with information of the application. The information of the application may include, for example, identification information (e.g., a name) of the application or version information of the application. The command center may store the configuration information for each application. In some examples, the command center may store the received configuration information in the database in association with the information of the application and device identification information. The command center may store the configuration information for each application and each device. For example, the configuration information may be stored for each device as shown in FIG. 4.

According to the above-described examples, since the configuration information obtained from another device is stored together with the application information, the configuration of the specific application may be modified by using the stored configuration information.

Referring to FIG. 6, a command center may receive a selection of a target application from among a plurality of applications from a user (e.g., a user terminal) at operation S610. The command center may display a status of each device related to the target application at operation S620. In some examples, the status of each device may include a status as to whether the target application is installed on the device.

When the command center receives a configuration request of the target application from the user at operation S630, a list of devices on which the target application is installed may be displayed at operation S640. When receiving a selection of the source device from the user at operation S650, the command center may request the source device to transfer configuration information of the target application at operation S660. The command center may receive the configuration information of the target application from the source device at operation S670. In some examples, the source device may provide the configuration information as a file including the configuration information. In some examples, the configuration information provided from the source device may include configuration values that have been configured in the source device.

In addition, the command center may request an application center to transfer default configuration information of the target application at operation S661, and may receive the default configuration information of the target application from the application center at operation S671. In some examples, the application center may provide the default configuration information as a file including the default configuration information. In some examples, the default configuration information may include configuration item information of an application, and a default configuration value and other configuration values, which may be selected besides the default configuration value, of each configuration item.

Although operations of operations S640 to S670 are shown before operations of operations S661 and S671 in FIG. 6, the order of the operations may be changed.

The command center may provide an application configuration interface based on the default configuration information received from the application center and the configuration information received from the source device at operation S680. In some examples, the application configuration interface may be displayed on the user terminal so that the user may modify the configuration information. In some examples, the application configuration interface may provide an interface for setting the other configuration value in a state in which the configuration value provided from the source device is set for each configuration item of the target application. Accordingly, the user may modify the configuration of the target application.

In some examples, a version of the target application installed in the source device may be different from a version of the target application corresponding to the default configuration information obtained from the application center. In this case, in an example, the application configuration interface may not display a configuration item that is not supported by the version of the target application installed in the source device among the configuration items of the default configuration information. In another example, the application configuration interface may display, as a configuration value of the default configuration information, a configuration item that is not supported by the version of the target application installed in the source device among the configuration items of the default configuration information. In yet another example, the application configuration interface may display a configuration item supported by a specific version of the target application together with information indicating the specific version.

When modification of the configuration of the application is completed through the application configuration interface at operation S690, the command center may store the modified configuration information in a database at operation S695. In some examples, the command center may store the modified configuration information in the database in association with information of the application. The information of the application may include, for example, identification information (e.g., a name) of the application or version information of the application. The command center may store the configuration information for each application. In some examples, the command center may store the received configuration information in the database in association with the information of the application and user information. The command center may store the configuration information for each application and each user. For example, the configuration information may be stored as shown in FIG. 4.

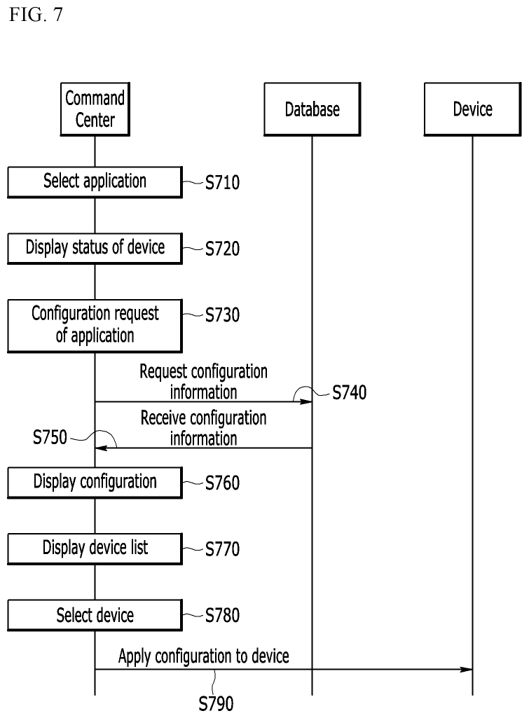

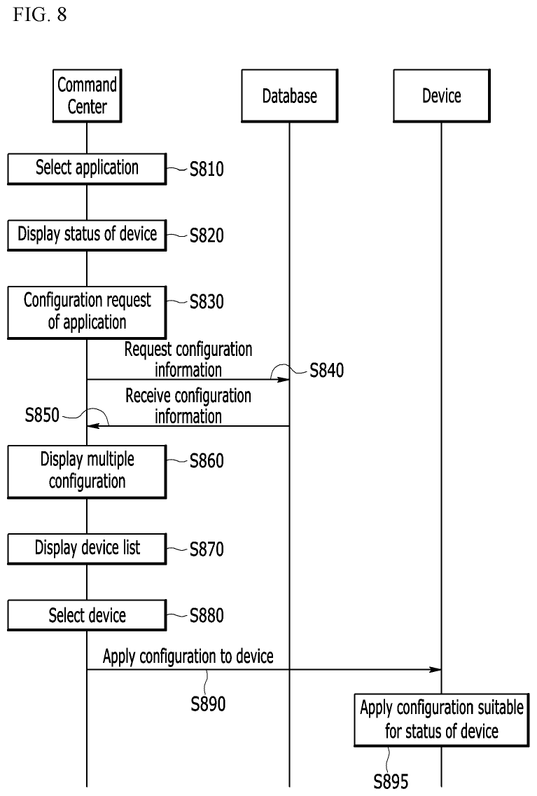

Various examples in which stored configuration information of a specific application is applied to a specific device are described with reference to FIG. 7 and FIG. 8.

FIG. 7 and FIG. 8 are diagrams showing a method of applying an application configuration according to various examples.

Referring to FIG. 7, a command center may receive a selection of a target application from among a plurality of applications from a user (e.g., a user terminal) at operation S710. The command center may display a status of each device related to the target application at operation S720. In some examples, the status of each device may include a status as to whether the target application is installed on the device.

When the command center receives a configuration request of the target application from the user at operation S730, configuration information stored for the target application may be displayed at operation S760. In some examples, the command center may request the database to transfer the configuration information of the target application in order to retrieve the configuration information stored for the target application at operation S740, and may receive the configuration information for the target application from the database at operation S750. In some examples, the configuration information may include configuration information obtained from another device. In some examples, the configuration information may include configuration information modified based on default configuration information. In some examples, the configuration information may include configuration information modified based on the default configuration information and the configuration information obtained from another device.

The command center may display a list of devices on which the target application is installed at operation S770. When receiving from the user a selection of the target device to which the displayed configuration information is to be applied at operation S780, the command center may apply the configuration information to the target device at operation S790. Accordingly, the configuration information transmitted from the command center may be applied to the target application installed in the target device.

According to the above-described examples, the configuration of the application may be modified by using the stored configuration information. Further, the application configuration applied to the device through the stored configuration information can be easily checked. Furthermore, since the stored configuration information is applied according to the user's device selection, it is possible to prevent the problem that the other configuration is applied by incorrectly selecting the configuration file.

Referring to FIG. 8, the command center may receive a selection of a target application from among a plurality of applications from a user (e.g., a user terminal) at operation S810. The command center may display a status of each device related to the target application at operation S820. In some examples, the status of each device may include a status as to whether the target application is installed on the device. In some examples, the command center may display a list of devices on which the target application is installed.

When the command center receives a configuration request of the target application from the user at operation S830, a plurality of configuration information stored for the target application may be displayed at operation S860. In some examples, the command center may request the database to transfer the configuration information of the target application in order to retrieve the configuration information stored for the target application at operation S840, and may receive the configuration information for the target application from the database at operation S850. In some examples, the configuration information may include configuration information obtained from another device. In some examples, the configuration information may include configuration information modified based on default configuration information. In some examples, the configuration information may include configuration information modified based on the default configuration information and the configuration information obtained from another device.

The command center may display a list of devices on which the target application is installed at operation S870. When receiving from the user a selection for the target device to which the displayed configuration information is to be applied at operation S880, the command center may apply the plurality of configuration information to the target device at operation S890. When the target application is executed on the target device, the target device may check a current status of the target device, select the configuration information suitable for the current status from the plurality of configuration information, and apply the selected configuration information to the target application at operation S895. In some examples, a configuration manager of the target device may check the current status of the target device and select the configuration information suitable for the current status.

According to the above-described examples, the configuration of the application may be modified by using the stored configuration information. Further, the application configuration applied to the device through the stored configuration information can be easily checked. Furthermore, the configuration information suitable for the current status of the device among the various configurations can be applied to the device.

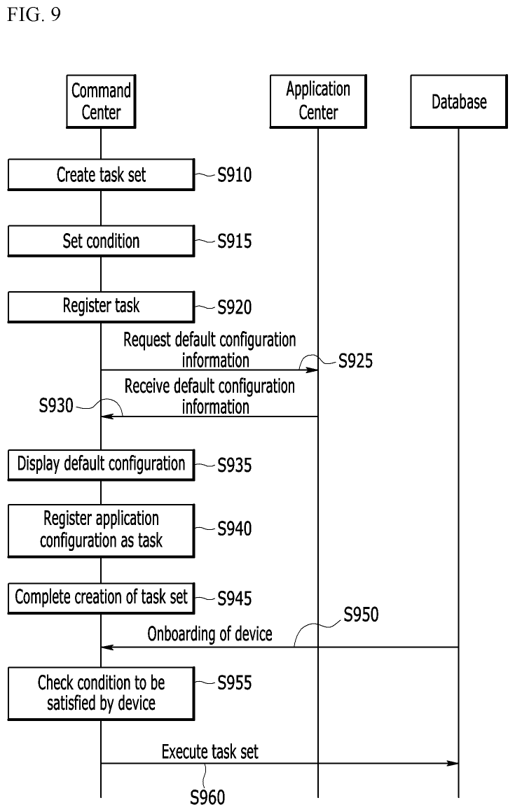

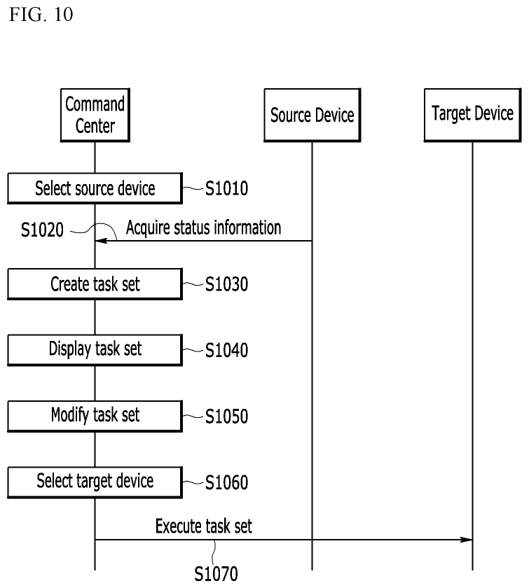

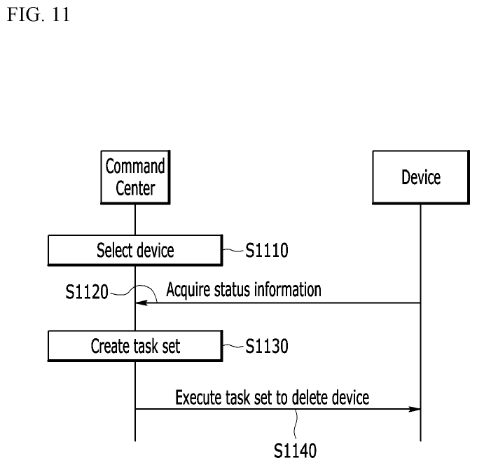

Although examples of modifying or applying a configuration of a specific application have been described, various configurations including a configuration of a device as well as the configuration of the specific application may be modified or applied. Hereinafter, such examples are described with reference to FIG. 9 to FIG. 11.

FIG. 9, FIG. 10, and FIG. 11 are diagrams showing a method of applying a task set according to various examples.

Referring to FIG. 9, a command center may create a task set by an operation of a user (e.g., a user terminal) at operation S910, and may set a condition under which the task set is applied by an operation of the user at operation S915. The condition may be selected from among various conditions, and may include, for example, a condition that a device is registered to a specific customer, a condition that the device is a specific model, a condition that an execution time is a specific time, and the like.

The command center may receive a task to be registered in a task set from the user and register the task in the task set at operation S920. The task may be a task related to management of the device itself or an application of the device, and may include, for example, a function configuration of the device, an installation of the application, a configuration of the application, and the like. If the task registered in the task set includes the installation of the application or the configuration of the application, the command center may request an application center to transfer default configuration information of the application corresponding to the configuration task at operation S925. The application center may receive the default configuration information of the application from the application center at operation S930, and may provide an application configuration interface in which default configuration information is applied based on the received default configuration information at operation S935. In some examples, the application configuration interface may be displayed on the user terminal so that the user may modify the configuration information.

When modification of the configuration of the application is completed through the application configuration interface, the command center may register the modified configuration information in the task set as a task of configuring the application at operation S940. Accordingly, creation of the task set is completed at operation S945. In some examples, instead of operations S925 to S940, the command center may register, as the task of configuring the application, configuration information of the application stored in a database in the task set according to a user's selection. In some examples, the command center may provide the application configuration interface based on the configuration information of the application stored in the database and the default configuration information according to the user's selection at operation S935.

When the device is registered in the command center through an onboarding procedure at operation S950, the command center may check whether a task set having a condition to be satisfied by the registered device exists at operation S955. The command center may execute the task set having the condition to be satisfied by the device and apply it to the device at operation S960. In some examples, the command center may execute the task set at the execution time stored as the condition. Accordingly, the device may be configured by the device configuration registered in the task set, the application registered in the task set may be installed in the device, or the application configuration in the task set may be applied to the application installed in the device.

According to the above-described examples, when the device is registered in the command center, the device can be configured to a desired status without error by executing a task set satisfying the condition of the device.

Referring to FIG. 10, the command center may receive a selection of a source device from a user (e.g., a user terminal) at operation S1010. The command center may acquire status information of the source device from the source device at operation S1020. The status information may include, for example, a device configuration of the source device, a list of applications installed in the source device, or configuration information of each of the applications.

The command center may create a task set based on the status information obtained from the source device at operation S1030 and may display a task list of the created task set at operation S1040. In some examples, the task set may include a device function configuration task, an application installation task, an application configuration task, and the like. When the user modifies the tasks of the task set, the command center may modify the task set at operation S1050. For example, the command center may delete the installation task of a specific application or the device function configuration task from the displayed task set according to the user's operation. Alternatively, the command center may add another task (e.g., a task of installing an application which is not installed on the source device) to the task set according to the user's operation.

When receiving a selection of a target device to which the task set is to be applied from the user at operation S1060, the command center may execute the task set on the target device and apply it to the target device at operation S1070. Accordingly, the target device may be configured to the device function configuration registered in the task set, the application registered in the task set may be installed in the target device, or the application configuration registered in the task set may be applied to the application installed in the target device.

According to the above-described examples, since the status of the device can be configured to the same status as the source device with the task set created based on the status information of the source device, the device can be configured to the desired status without error.

Referring to FIG. 11, a command center may receive a selection of a target device to be deleted from among registered devices from a user (e.g., a user terminal) at operation S1110. The command center may acquire status information of the target device from the target device at operation S1120. The status information may include, for example, a device function configuration of the target device, a list of applications installed in the target device, configuration information of each of the applications, and the like.

The command center may create a task set based on the status information obtained from the target device at operation S1130. In some examples, the task set may include a task of deleting an installed application or a task of disabling an enabled device function of the target device. In some examples, the task set may further include a task of deleting the target device from the registered device list. The command center may apply the task set to the target device by executing the task set on the target device at operation S1140. Accordingly, the device function enabled in the target device may be disabled or the installed application may be deleted. In addition, the target device may be deleted from the registered device list managed by the command center.

According to the above-described examples, since the device can be deleted by the task set created based on the status information of the device, the device can be set to a state in which the device can be onboarded without conflict at another customer site.

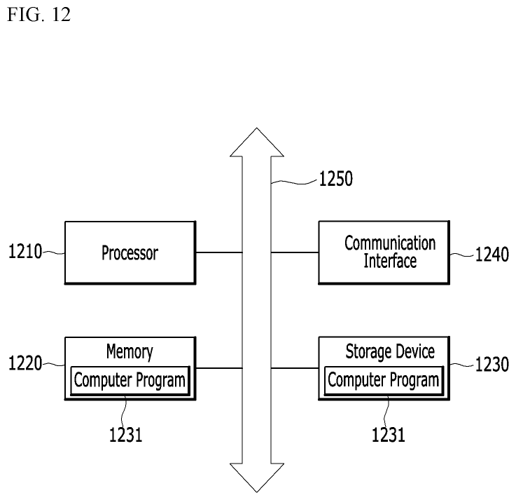

In some examples, a command center, an application center, a database, a method of configuring an application, a method of applying an application configuration, or a method of applying a task set may be implemented by a computing device having computing functions. An example computing device is described with reference to FIG. 12. Although FIG. 12 shows an example implemented with one computing device, the above-described device or method may be implemented by a plurality of computing devices.

FIG. 12 is a diagram showing a computing device according to an example.

Referring to FIG. 12, a computing device includes a processor 1210, a memory 1220, a storage device 1230, a communication interface 1240, and a bus 1250. The computing device may further include other general components.

The processor 1210 may control an operation of each component of the computing device. The processor 1210 may be implemented with processing circuitry. For example, the processing circuitry may include a central processing unit (CPU), an application processor (AP), a microprocessor unit (MPU), a micro controller unit (MCU), an arithmetic logic unit (ALU), a graphic processing unit (GPU), a digital signal processor, a field programmable gate array (FPGA), a system on chip (SoC), a programmable logic unit, or an application-specific integrated circuit (ASIC). In addition, the processor 1210 may perform operations on a program for executing the above-described method.

The memory 1220 may store various data, commands, and/or information. The memory 1220 may load a computer program 1231 from the storage device 1230 to execute the above-described example method. The storage device 1230 may non-temporarily store the program 1231. The storage device 1230 may be implemented as a non-volatile memory.

The communication interface 1240 may support wired or wireless Internet communication of the computing device. The communication interface 1240 may support various communication methods other than the Internet communication.

The bus 1250 may provide a communication function between components of the computing device. The bus 1250 may be implemented as various types of buses such as an address bus, a data bus, and a control bus.

The computer program 1231 may include instructions that cause the processor 1210 to perform an above-described example method when loaded into memory 1220. That is, the processor 1210 may perform operations for the above-described example method by executing the instructions.

In some examples, a method of configuring an application, a method of applying an application configuration, or a method of applying a task set may be implemented as a computer-readable program on a non-transitory computer-readable medium. In some examples, the non-transitory computer-readable medium may include, for example, a removable recording medium or a fixed recording medium. In some examples, the computer-readable program recorded on the non-transitory computer-readable medium may be transmitted to another computing device via a network such as the Internet and installed in the other computing device, so that the computer program can be executed by the other computing device.

Although various examples have been described above, the scope of the present invention is not limited thereto, and various modifications and improvements by those skilled in the art using the basic concepts defined in the following claims also fall within the scope of rights.

What is claimed is:

1. A computing apparatus comprising:
a communication interface connected via a network with a plurality of image forming apparatuses;
a memory; and
a processor to execute instructions of a program loaded in the memory to:
receive, from a server, default configuration information of a target application whose configuration is to be modified among a plurality of applications;
provide an interface for modifying the configuration of the target application based on the default configuration information; and
apply first configuration information modified through the interface to the target application of a first image forming apparatus in which the target application is to be configured among the plurality of image forming apparatuses.

2. The computing apparatus of claim 1,
wherein the processor is further to receive second configuration information of the target application from a second image forming apparatus among the plurality of image forming apparatuses, and
wherein the interface is provided based on the default configuration information and the second configuration information.

3. The computing apparatus of claim 2, wherein, when a first version of the target application corresponding to the default configuration information is different from a second version of the target application installed in the second image forming apparatus, the interface provides no configuration item that is not supported by the second version among a plurality of configuration items of the default configuration information.

4. The computing apparatus of claim 2, wherein, when a first version of the target application corresponding to the default configuration information is different from a second version of the target application installed in the second image forming apparatus, and a plurality of configuration items comprising a first configuration item that is supported by the second version and a second configuration item that is not supported by the second version is provided, the interface provides a default configuration value of the first configuration item based on the second configuration information and a default configuration value of the second configuration item based on the default configuration information.

5. The computing apparatus of claim 1, wherein the interface provides a configuration item that is supported by a predetermined version of the target application among a plurality of configuration items of the default configuration information, together with information indicating the predetermined version.

6. The computing apparatus of claim 1,
wherein the first configuration information comprises a plurality of configuration information, and
wherein configuration information that is suitable for a status of the first image forming apparatus among the plurality of configuration information is applied to the first image forming apparatus.

7. The computing apparatus of claim 1, wherein the server stores the plurality of applications and a file comprising default configuration information of each of the plurality of applications.

8. A computing apparatus comprising:
a communication interface connected via a network with a plurality of image forming apparatuses;
a memory; and
a processor to execute instructions of a program loaded in the memory to:
create a task set comprising a first task of managing an application and a second task of configuring a function of a device; and
apply the task set to a first image forming apparatus among the plurality of image forming apparatuses such that the first task and the second task are executed in the first image forming apparatus.

9. The computing apparatus of claim 8,
wherein the task set further comprises a condition, and
wherein the first image forming apparatus comprises an image forming apparatus satisfying the condition among the plurality of image forming apparatuses.

10. The computing apparatus of claim 8, wherein the first image forming apparatus comprises an image forming apparatus that registers with the computing apparatus among the plurality of image forming apparatuses.

11. The computing apparatus of claim 10,
wherein the first task comprises a task of installing the application, and
wherein the task set further comprises a third task of configuring the application.

12. The computing apparatus of claim 8, wherein the processor is further to:
receive status information of a second image forming apparatus among the plurality of image forming apparatuses from the second image forming apparatus; and
create the task set based on the status information.

13. The computing apparatus of claim 8,
wherein the processor is further to:
receive status information of the first image forming apparatus from the first image forming apparatus; and
create the task set based on the status information,
wherein the first task comprises a task of deleting the application,
wherein the second task comprises a task of disabling the function, and
wherein the task set further comprises a task of deregistering the first image forming apparatus.

14. A non-transitory computer readable medium comprising:
instructions to request a server to transfer default configuration information of a target application among a plurality of applications;
instructions to receive the default configuration information from the server;
instructions to provide an interface for modifying a configuration of the target application based on the default configuration information; and
instructions to configure the target application of a target image forming apparatus among a plurality of image forming apparatuses based on configuration information modified through the interface.

15. The non-transitory computer readable medium of claim 14, further comprising:
instructions to create a first task of installing the target application;
instructions to create a second task of configuring the target application based on the modified configuration information; and
instructions to create a task set comprising the first task and the second task,
wherein the configuring of the target application comprises applying the task set to the target image forming apparatus.
